(19) United States
(12) Patent Application Publication
(10) Pub. No.: US 2003/0129911 A1
(43) Pub. Date: Jul. 10, 2003

(54) Waterproof construction and method of making same

(76) Inventor: Michael A. Lewallyn, Dalton, GA (US)

Correspondence Address: Harry M. Levy, Esq., EMRICH & DITHMAR, Ste. 3000, 300 S. Wacker Dr., Chicago, IL, 60606, US

(21) Appl. No.: 10/306,308

(22) Filed: Nov. 27, 2002

Related U.S. Application Data
(60) Provisional application No. 60/333,783, filed on Nov. 28, 2001.

(51) Int. Cl. D04H 11/00; D04H 1/00; D04H 5/00; B32B 33/00

(52) U.S. Cl. 442/386; 428/85; 442/327

(57) ABSTRACT

A laminate and method of making same is disclosed. The laminate includes a base layer and a low melt layer directly or indirectly bonded on one side thereof to the base layer and a product layer adhered to the other side of said low melt layer; the low melt layer extends beyond the product layer along a peripheral portion thereof. The low melt layer when in registry with an adjacent laminate and subjected to heat bonds with and forms a substantially water tight seal with the adjacent laminate. Various base, low melt and product layers are disclosed.

### RELATED APPLICATION

This application, pursuant to 37 C.F.R. § 1.78(c), claims priority based on provisional application serial No. 60/333,783 filed Nov. 28, 2001.

### FIELD OF THE INVENTION

This invention relates to a construction which includes a product adhered to a film laminate made-up of at least two layers, one of which is a low melting layer with a portion of the laminate extending outwardly of the product to form a flap which may be assembled with a like constructions and thereafter heat sealed to form a substantially waterproof assemblage.

### BACKGROUND OF THE INVENTION

A variety of laminated constructions are required to be substantially waterproof, for instance carpet pads, under layments for wood flooring, a variety of geo-textiles for placement under landfills or at the bottom of ponds or on farms with ponds for hog sewage. In all cases, forming waterproof constructions in the field from a plurality of pieces is difficult, often resulting in less than desirable results.

### BRIEF SUMMARY OF THE INVENTION

In broad terms, the present invention includes a construction and a process of making same in which a product layer has a waterproof laminate on one side thereof which extends beyond the product layer to form a flap. The product to which the laminate is adhered may be any one of a wide variety of materials including: carpet pads, floor under layment, open or closed cell foam including polyurethane, nylon weave backing for carpets, various non-woven materials and many others. The laminate adhered to the product is usually a multi-layer laminate in which there is a strengthening or substrate layer which may be made with a variety of materials including but not limited to polypropylene, polyester, polyethylene, nylons, PVC's, other vinyls and various mixtures, blends and co-polymers thereof. To this substrate layer or strengthening layer is laminated a low melting layer which may include but is not limited to ethylene vinyl acetate, polyester co-polymers, polyolefins, polyamides and various mixtures, blends and co-polymers thereof. The preferred melting point of the low melting portion of the film laminate is generally above 180° F. and preferably in the range of about between 195° F. to about 325° F. The preferred method of making the construction of the invention includes registering the product and the film laminate with the low melt layer in contact with the product and passing the registered laminate and product over a heated roller, preferably a heated drum, for a time sufficient to melt the low melt laminate to the product thereby affixing the laminate film to the product. Most importantly, a flap of the low melt material extends outwardly of the product so that when sections of the construction are mated, the overlapping flap, when heat sealed, provides a substantially moisture proof seal at the seams between adjacent constructions. This is a fundamental feature of the invention.

Other features and advantages of the present invention will be apparent to persons skilled in the art of the following detailed description of one embodiment accompanied by the attached drawing wherein identical reference numerals refer to like parts in the various views.

### BRIEF DESCRIPTION OF THE DRAWINGS

FIG. 1 is a schematic sectional view of a laminate film heat bonded to a product showing the construction of the present invention;

FIG. 2 is a schematic representation of adjacent constructions being positioned in order to form a moisture or watertight seam.

FIG. 3 is an illustration showing the waterproofing of the seam formed in FIG. 2;

FIG. 4 is an elevational perspective view of a film laminate of the present invention showing an edge portion thereof to enlarged to illustrate the laminated construction; at the bottom of FIG. 4 is a representation of the prior art method of forming waterproof seams;

FIG. 5 is a side-elevational view of a second embodiment of the laminated film;

FIG. 6 is a side view of an apparatus for producing a composite structure of the invention; and

FIG. 7 is a detailed side view of the heated roller of the embodiment of FIG. 6.

### DETAILED DESCRIPTION OF THE EMBODIMENTS

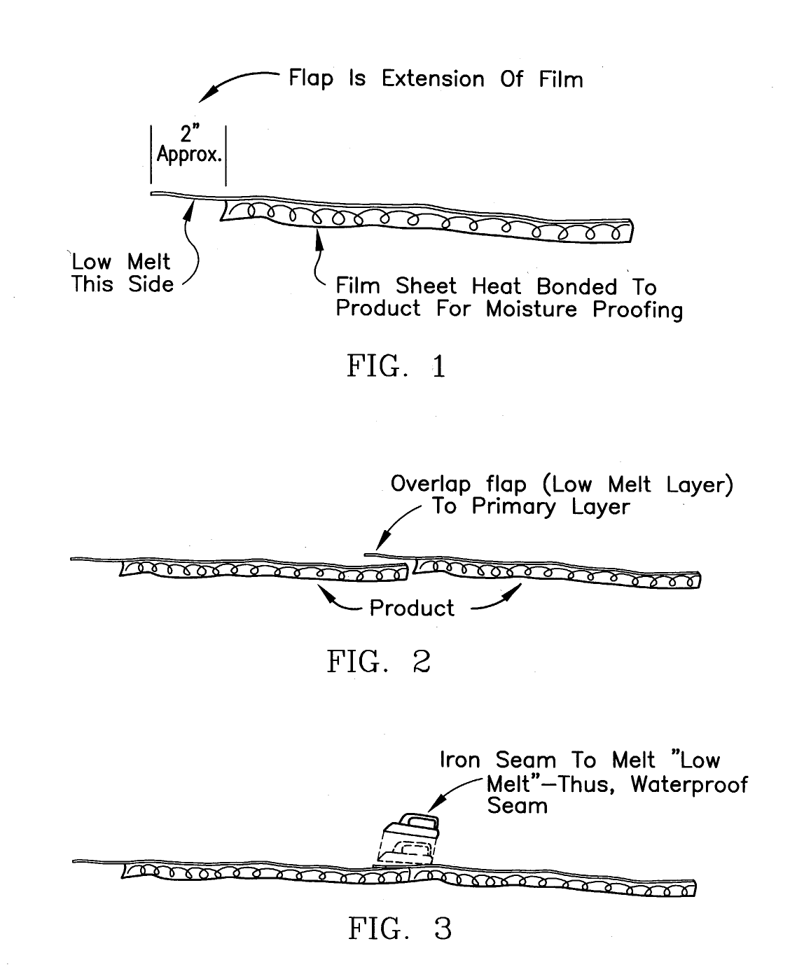

As illustrated in FIGS. 1 to 5, the construction of the present invention is a combination of a film having at least one side thereof a low melt layer and a product arranged in such a way that there is a low melt flap extending from at least one end of the product which enables adjacent segments of the construction including the product to be connected in a substantially moisture proof or waterproof manner. A wide variety of constructions are available and FIG. 1 shows the placement of a laminate over a product to form a construction with a flap of approximately two inches which is later used to form a waterproof seam. The product layer may be any one of a wide variety of materials including but not limited to, carpet pads, wood floor under laminates, tile floor under laminates, closed or open cell foams such as polyurethanes, non-woven fabrics, synthetic organic resin weave backing for carpets or scrap synthetic fiber pad carpet underlayment. One significant use of the invention is in carpet padding in which adjacent sections of carpet padding need to be connected in a way so as to form a substantially water proof seam between the adjacent segments so that if a liquid is spilled on the carpeting, little if any liquid will seep through the seams of the carpet padding to pool therebelow. This is an important requirement in the carpet industry and in other industries in which under layments are required.

The film laminate may be any numbers of layers, generally two or three. There is a strengthening or substrate layer to which is either directly or indirectly attached a low melt layer. The substrate or strengthening layer can be any one of a wide variety of materials including but not limited to polypropylene, polyester, polyethylene, nylons or other polyamides, PVC's, other vinyls, substituted and unsubstituted, and various mixtures, blends and copolymers thereof; however, polypropylene is preferred. In a two layer laminate, the low melt layer is directly in contact with the substrate or strengthening layer. The low melt layer may be, but is not limited to, ethylene vinyl acetates, polyesters, polyester copolymers, polyolefins, polyamides, and various mixtures, blends and copolymers thereof; however, polyethylene is preferred. Generally, it is preferred that the low melting layer have a melting point above 180° F. but most preferably in the range of from about 195° F. to about 325° F. Temperatures somewhat lower and somewhat higher may be used without adversely effecting the construction of the present invention, but most preferably the melt temperature is about 200° F.

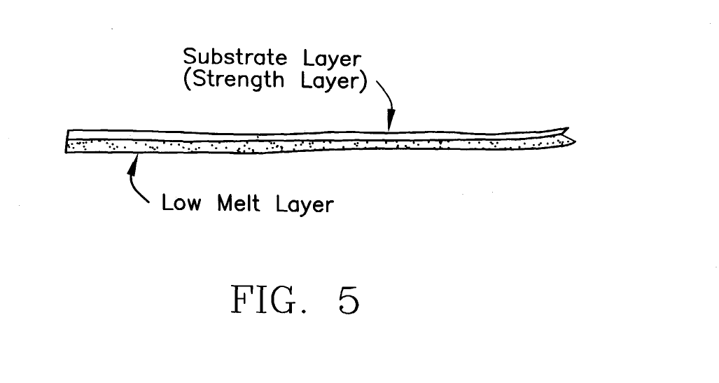

In some cases as illustrated in FIG. 5, there may be a three or more layer construction in which there is a primary substrate or strengthening layer of the material herein set forth followed by a co-polymer substrate which may be a combination of the strengthening or primary substrate material and a low melt material followed by a layer of the low melt material. The preferred construction is a polypropylene substrate bonded to a low melt polyethylene with a copolymer of polypropylene and polyethylene. Other more complicated constructions are entirely within the invention. In the present construction, it is imperative that a flap of low melt material extend outwardly from the product at least at one end of the construction in order to form the overlapping structures shown in FIG. 2 followed by a heating step as in FIG. 3 to provide a substantially water tight construction of the present invention. While FIG. 3 shows, for purposes of illustration only, a hand iron, other means of heating may be used.

The invention is primarily, but not restrictively, intended for use in situ or in the field, for instance, by carpet installers where the product is carpet padding or by wood floor installers where the product is hard wood or laminated wood floor under layment. In these instances, an installer's heating iron ir household iron may be used. It is important in these applications for the water tight constructions shown in FIG. 3 to be able to be produced quickly and efficiently in the field without requiring adhesives or two-way tape and without the requirement of sophisticated and expensive equipment. A hand iron is illustrated but other more sophisticated devices such as rolling heaters may also be used.

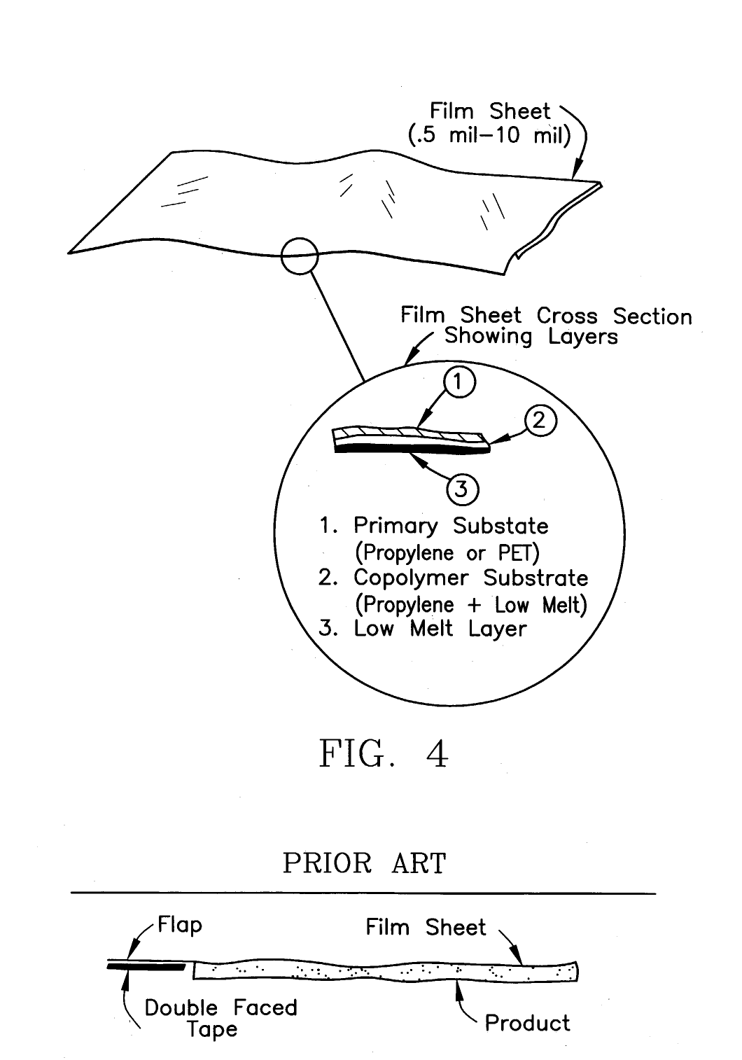

Various companies such as Dupont, D&K, Sierra and others make various laminates which are suitable for the present invention. As illustrated in FIG. 4, before the present invention, double faced tape was used between adjacent segments in order to provide a water tight seal, as well as adhesives, as taught in U.S. Pat. No. 5,952,076 issued Sep. 14, 1999 to Foster. The use of double faced tapes or adhesives in the field is messy and generally unsatisfactory whereas, the use of the present invention is far easier and more economical, and has enjoyed commercial success.

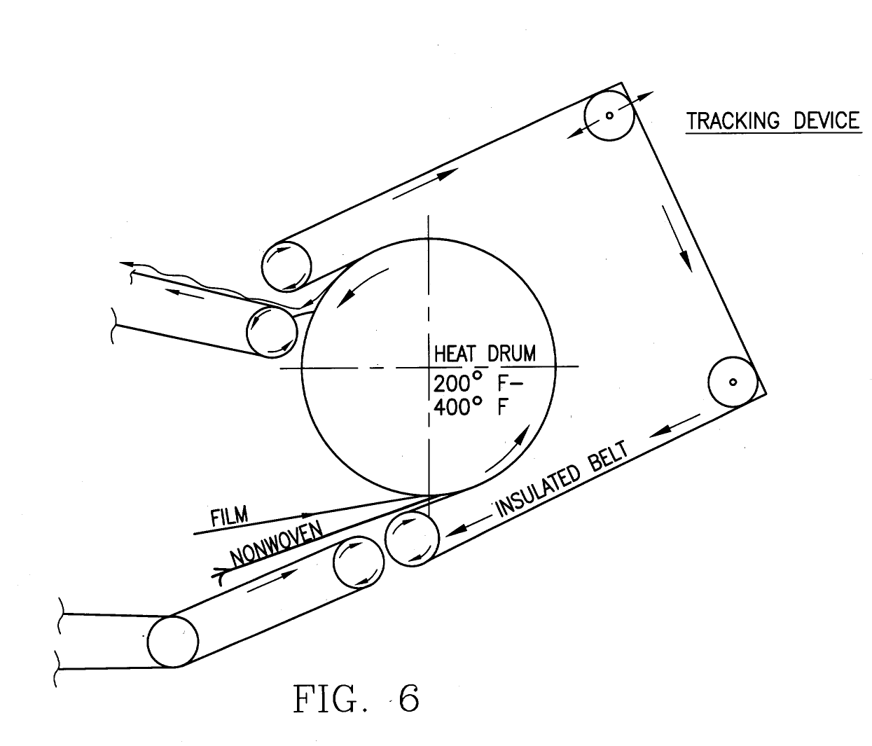

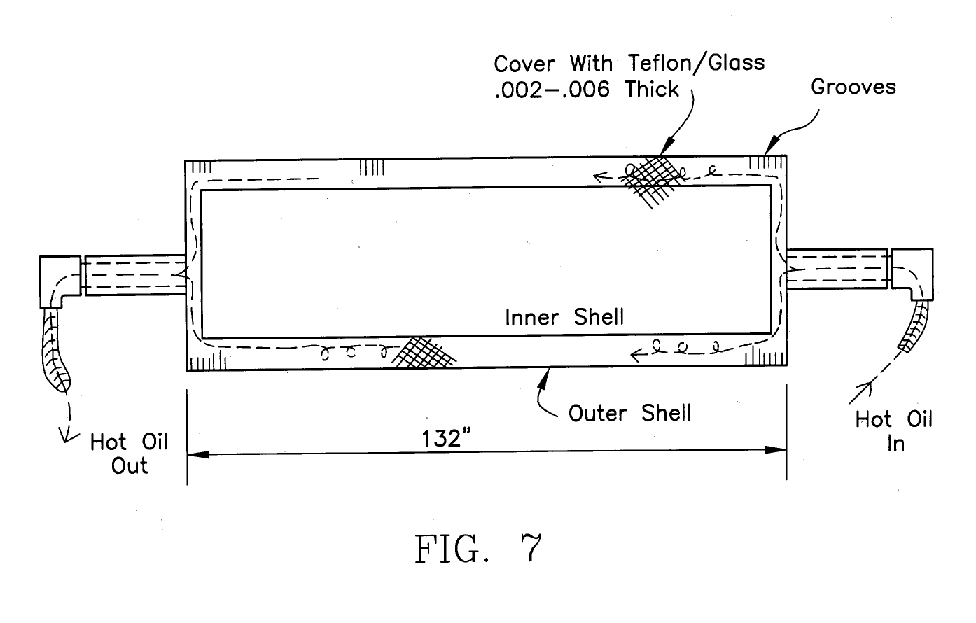

Illustrated in FIG. 6 is a heating station including a heated drum which has a length preferably somewhat greater than the width of the film and underlying product being bonded together to form the composite construction. The roller construction of FIG. 6 is better illustrated in FIG. 7 but includes an annular region made of a good heat conductor such as steel around an inner shell as seen in FIG. 7. The inner and outer shells of the drum are actually spaced apart to form an annular hollow interior region through which heated oil flows and is re-circulated from a suitable source, so as to heat the outer shell to a temperature appropriate for adhering the film to the product forming the construction. The film is positioned so that preferably the product does not touch the heated drum but the film with the low melt side facing the product is in contact with the heated drum, thereby causing the heat to pass through the laminate and melt the low melt side in contact with the product to produce the construction of the present invention. A flap is continuously produced on one or both sides by having the laminate wider than the product so that the construction is formed as illustrated in FIG. 1. A chiller (not shown) may be used if required to cool the low melt layer required. Running speeds and the temperature of the heated roller are dependant on the specific product and laminates being run, but may be determined by one of ordinary skill in the art, without undue experimentation. Although FIG. 6 illustrates a film and non-woven layer, as previously disclosed the non-woven layer may a variety of materials including but not limited to carpet or wood floor underlayment, while the film may be a strengthening layer and a low melt layer. The product layer or in FIG. 6, the non-woven layer, may be a variety of thicknesses, anywhere from 1/16 inches to ¾ inches.

The method of the present invention is illustrated in the drawings. A two layer construction of FIG. 5 is made by registering a substrate layer or strengthening or base layer and a low melt layer with the low melt layer extending beyond the base or substrate or strengthening layer and passing these registered layers over a heated roller as shown in FIGS. 6 and 7.

A product layer may be added to the two layer construction of FIG. 5 as illustrated in FIG. 6 with the layer denoted as film being the two layer construction of FIG. 5. After heating, the three layer construction of FIG. 6 is formed with both the exterior layers being bonded directly to the low melt layer and indirectly bonded to each other. The low melt layer has at least one edge extending beyond the base or substrate layer in a two ply construction or extending beyond the base substrate layer and registered product layer in a three ply construction.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

What is claimed is:

1. A laminate comprising a base layer and a low melt layer directly or indirectly bonded on one side thereof to said base layer and a product layer adhered to the other side of said low melt layer, said low melt layer extending beyond said product layer along a peripheral portion thereof, wherein said low melt layer when in registry with an adjacent laminate and subjected to heat bonds with and forms a substantially water tight seal with the adjacent laminate.

2. The laminate of claim 1, wherein said base layer is one or more of a polypropylene, a polyester, a polyethylene, a polyamide, a polyvinyl chloride, a substituted vinyl, and mixtures, blends and copolymers thereof.

3. The laminate of claim 1, wherein said low melt layer is one or more of an ethylene vinyl acetate, a polyester copolymer, a polyolefin, a polyamide and mixtures, blends and copolymers thereof.

4. The laminate of claim 2, wherein said low melt layer is one or more of an ethylene vinyl acetate, a polyester copolymer, a polyolefin, a polyamide and mixtures, blends and copolymers thereof.

5. The laminate of claim 4, wherein said base layer is polypropylene.

6. The laminate of claim 4, wherein said low melt layer is polyethylene.

7. The laminate of claim 6, wherein said polypropylene base layer is bonded to said low melt polyethylene layer with a copolymer of polypropylene and polyethylene.

8. The laminate of claim 1, wherein said low melt layer has a melting point greater than about 180° F. and less than about 325° F.

9. The laminate of claim 7, wherein the said low melt layer has a melting point in the range of from about 195° F. to about 325° F.

10. The laminate of claim 1, wherein the low melt layer extends outwardly of said product layer not less than about 2 inches.

11. The laminate of claim 10, wherein said product layer is one or more of a non-woven fabric, a carpet underlayment, a wood floor underlayment, a polyurethane foam, or a synthetic organic resin weave backing for carpet.

12. A laminate comprising a base layer and a low melt layer bonded thereto and a product layer, wherein said base layer is one or more of a polypropylene, a polyester, a polyethylene, a polyamide, a polyvinyl chloride, a substituted vinyl, and mixtures, blends and copolymers thereof and said low melt layer is one or more of an ethylene vinyl acetate, a polyester copolymer, a polyolefin, a polyamide and mixtures, blends and copolymers thereof, said low melt layer having a melting point not greater than about 325° F., wherein at least one edge of said low melt layer extends beyond said product layer such that it is capable of overlapping an adjacent laminate and forming a substantially water tight seal therewith.

13. The laminate of claim 12, wherein said base layer includes polypropylene or a blend, mixture or copolymer thereof.

14. The laminate of claim 12, wherein said low melt layer includes polyethylene or a blend, mixture or a copolymer thereof.

15. The laminate of claim 13, wherein said low melt layer includes polyethylene or a blend, mixture or a copolymer thereof.

16. The laminate of claim 15, wherein the side of said low melt layer opposite said base layer is bonded directly or indirectly to one or more of a product layer selected from a non-woven fabric, a carpet underlayment, a wood floor underlayment, a polyurethane foam or a synthetic organic resin weave backing for carpet.

17. The laminate of claim 16, wherein said base layer is polypropylene, said low melt layer is polyethylene bonded thereto with a copolymer of polypropylene and polyethylene.

18. The laminate of claim 17, wherein said low melt layer is bonded to said polypropylene base layer and a carpet underlayment.

19. The laminate of claim 17, wherein said low melt layer is bonded to said polypropylene base layer and a wood floor underlayment.

20. The laminate of claim 17, wherein said low melt layer is bonded to said polypropylene base layer and a polyurethane layer.

21. The laminate of claim 17, wherein said low melt layer is bonded to said polypropylene base layer and a scrap synthetic fiber pad carpet underlayment.

22. A laminate comprising a base layer and a low melt polyethylene layer directly or indirectly bonded to one side of said base layer and a product layer bonded directly or indirectly to said low melt polyethylene layer opposite to said base layer said low melt polyethylene layer extending beyond said base layer and said product layer along a peripheral portion thereof, wherein said low polyethylene melt layer when in registry with an adjacent laminate and subjected to heat bonds with and forms a substantially water tight seal with the adjacent laminate.

23. The laminate of claim 22, wherein said base layer is polypropylene and said low melt layer is polyethylene having a melting point greater than about 180° F. and less than about 325° F. and said another layer is at least about 1/16 inch in thickness and is a synthetic organic resin.

24. The laminate of claim 23, wherein said base layer and said low melt polyethylene layer are bonded with a copolymer of polypropylene and polyethylene.

25. The laminate of claim 24, wherein said low melt layer has a melting point of about 200° F.

26. The laminate of claim 25, wherein said product layer is one or more of a non-woven fabric, a carpet underlayment, a wood floor underlayment, a polyurethane foam, or a synthetic organic resin weave backing for carpet.

27. A method of forming a laminate comprising
registering a film layer having a low melting point surface with a product layer such that one edge of the low melting point surface extends beyond the product layer and passing the so registered layers through a heating station to cause the layers to be bonded.

28. The method of claim 27, wherein the film layer having a low melting point surface includes polyethylene.

29. The method of claim 28, wherein the polyethylene has a melting point greater than 180° F. and less than about 325° F.

30. The method of claim 29, wherein the heating station includes a drum filled with a heated fluid.
